(19) United States
(12) Patent Application Publication
(10) Pub. No.: US 2024/0181538 A1
(43) Pub. Date: Jun. 6, 2024

(54) SYSTEMS AND METHODS FOR DETECTING RECOATING DEFECTS DURING ADDITIVE MANUFACTURING PROCESSES

(71) Applicant: VulcanForms Inc., Burlington, MA (US)

(72) Inventors: Mari Saif, Woburn, MA (US); Yiqun Xue, Belmont, MA (US); Rui Guo, Burlington, MA (US)

(73) Assignee: VulcanForms Inc., Burlington, MA (US)

(21) Appl. No.: 18/524,267

(22) Filed: Nov. 30, 2023

Related U.S. Application Data
(60) Provisional application No. 63/429,223, filed on Dec. 1, 2022.

(51) Int. Cl. B22F 12/90; B22F 10/28; B22F 10/36; B22F 10/85; B22F 12/30; B22F 12/50; B33Y 10/00; B33Y 30/00; B33Y 50/02; B33Y 80/00

(52) U.S. Cl. CPC B22F 12/90; B22F 10/28; B22F 10/36; B22F 10/85; B22F 12/30; B22F 12/50; B33Y 10/00; B33Y 30/00; B33Y 50/02; B33Y 80/00; B22F 2998/10

(57) ABSTRACT

In some embodiments, systems and methods are related to identifying recoating defects based at least in part on imaged light intensities are disclosed. In other embodiments, systems and methods for predicting the formation of part defects during an additive manufacturing process based at least in part on information related to the presence of recoating defects are disclosed.

### RELATED APPLICATIONS

This application claims priority under 35 U.S.C. § 119(e) to U.S. Provisional Application No. 63/429,223, filed Dec. 1, 2022, the content of which is incorporated by reference in its entirety for all purposes.

### FIELD

Disclosed embodiments are generally related to systems and methods for detecting recoating defects during additive manufacturing process.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object.

### SUMMARY

In some embodiments, an additive manufacturing system comprises a build surface, one or more laser energy sources, an optics assembly configured to direct laser energy from the one or more laser energy sources toward the build surface, a photosensitive detector configured to image at least a portion of the build surface, a recoater configured to deposit sequential layers of precursor material on the build surface, and at least one processor. The at least one processor is configured to obtain images of a plurality of layers of precursor material on the build surface prior to fusing using the photosensitive detector. The plurality of layers include at least one previous layer and a current layer. The at least one processor is also configured to predict formation of potential part defects in the current layer prior to fusing based at least in part on the images.

In some embodiments, a method for predicting part defects during an additive manufacturing process comprises obtaining images of a plurality of layers of precursor material on a build surface of an additive manufacturing system prior to fusing. The plurality of layers include at least one previous layer and a current layer. The method further comprises predicting formation of potential part defects in the current layer prior to fusing based at least in part on the images.

In some embodiments, a method of training a recoating defect detection statistical model comprises obtaining training data. The training data includes information related to part defects in a plurality of parts and information associated with images of recoated precursor material layers prior to fusing and associated with forming the plurality of parts. The method further comprises generating a trained statistical defect prediction model using the training data, and storing the trained statistical defect prediction model on non-transitory computer readable memory for subsequent use.

In some embodiments, an additive manufacturing system comprises a build surface, one or more laser energy sources, an optics assembly configured to direct laser energy from the one or more laser energy sources toward the build surface, one or more lights configured to illuminate the build surface, a photosensitive detector configured to image at least a portion of the build surface, a recoater configured to deposit sequential layers of precursor material on the build surface, and at least one processor. The at least one processor is configured to obtain an image of at least a portion of the current layer prior to fusing the current layer using the photosensitive detector and identify recoating defects in the current layer based at least in part on light intensities in the image.

In some embodiments, a method of detecting recoating defects on a build surface of an additive manufacturing system comprises obtaining an image of at least a portion of the build surface with a recoated precursor layer disposed on the build surface and identifying the recoating defects based at least in part on light intensities in the image.

In some embodiments, an additive manufacturing system comprises a build surface, one or more laser energy sources, an optics assembly configured to direct laser energy from the one or more laser energy sources toward the build surface, a photosensitive detector configured to image at least a portion of the build surface, a recoater configured to deposit sequential layers of precursor material on the build surface, and at least one processor. The at least one processor is configured to obtain one or more fusing energy maps including information related to energy applied to different portions of one or more layers of precursor material on the build surface, obtain one or more images of the one or more layers prior to fusing using the photosensitive detector, and predict formation of potential part defects in a current layer prior to fusing based at least in part on the one or more images and the one or more fusing energy maps.

In some embodiments, a method for predicting part defects during an additive manufacturing process comprises obtaining one or more fusing energy maps including information related to energy applied to different portions of one or more layer of precursor material on a build surface of an additive manufacturing system, obtaining one or more images of the one or more layers prior to fusing using a photosensitive detector, and predicting formation of potential part defects in a current layer prior to fusing based at least in part on the one or more images and the one or more fusing energy maps.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows an additive manufacturing system according to some embodiments;

FIG. 4 shows a lighting arrangement for a build surface according to some embodiments;

FIG. 5A shows a top view of a part after a layer of precursor material has been fused according to some embodiments;

FIG. 5B shows a top view of a part after a recoating with a precursor material according to some embodiments;

FIG. 5C shows a top view of a part after a defective recoating with a precursor material according to some embodiments;

FIG. 6 shows a fusing energy map according to some embodiments;

FIG. 7A shows a build plate containing parts being built including defects according to some embodiments;

FIG. 7B shows a fusing energy map according to some embodiments;

FIG. 7C shows a defect map according to some embodiments;

FIG. 7D shows a defect map after removing potential defects in low energy areas identified in the fusing energy map according to some embodiments;

FIG. 8A shows a flow diagram of one embodiment of a method for identifying potential part defects that may be formed during fusing of a current layer of recoated precursor material disposed on a build surface of an additive manufacturing system;

FIG. 8B shows a flow diagram of one embodiment of a method for preprocessing images and identifying recoating defects for use in additive manufacturing systems;

FIG. 9 is a schematic diagram of one embodiment of a method for training an image-based recoating defect detection statistical model; and

FIG. 10 presents a schematic representation of one embodiment of a computing device that may be configured to implement any of the methods disclosed herein.

### DETAILED DESCRIPTION

Laser powder bed fusion is an additive manufacturing process that has been used in many industries. Different industries and applications may have varying standards for part quality, with some industries and applications requiring parts with higher quality (i.e., fewer and/or less severe part defects). Parts determined to be below their respective standard of quality may be discarded as waste, increasing time, cost, and material expenditures. Defects may occur while building parts using additive manufacturing systems, lowering the overall quality of the part. For example, weld defects, recoating defects, contamination, and other issues may occur either prior to, during, and/or after the fusing of a precursor material in a particular layer. Depending on the severity, location relative to other defects, and other concerns, these defects may result in part defects in the overall final part.

In particular, the Inventors have recognized that recoating defects may influence the types and severity of part defects that may be formed, and thus, identifying recoating defects that may result in subsequent formation of part defects may be desirable in some applications. Recoating is the process in laser powder bed fusion of depositing a layer of precursor material on a build surface which may be fused during the build process to form individual layers of the one or more parts being formed. A common recoating defect that may be formed during recoating is a short feed. Short feeds occur when a layer of recoated material does not sufficiently cover a portion of previously fused material leaving a portion of the fused layer exposed. Other recoating defects that may occur include, but are not limited to, chatter lines associated with vertical oscillations of a recoater blade, drag lines associated with recoater blade defects and/or contaminants being dragged over a build surface, voids and/or mounds on the precursor layer resulting from flinging (i.e., when the recoater blade contacts and flexes a portion of fused material and the fused material springs back to its original position flinging precursor material aside creating voids and/or mounds on the precursor material layer), and any other undesired distribution or non-uniformity in a layer of precursor material resulting from the recoating process. Recoating defects may occur for a variety of reasons, including misaligned components, damaged components, unsupported parts, weld defects (e.g., balling) present on a current or preceding layer, contamination on the build surface, variations in process parameters, and/or other variations in the additive manufacturing process.

In view of the above, the Inventors have recognized the benefits associated with identifying the presence of recoating defects as well as predicting the likely formation of part defects due to the presence of these recoating defects. This detection and/or prediction may facilitate implementing potential corrective actions that may be taken to mitigate, or potentially eliminate, the formation of part defects in the one or more parts being formed during an additive manufacturing process. This may include various actions including, but not limited to, adjusting one or more process parameters, performing one or more additional recoats, scraping the build surface, or any other corrective action or adjustment as described herein to help mitigate or eliminate the potential for part defects to be generated.

In some embodiments, the formation of part defects may be predicted at least in part by obtaining one or more images of a build surface and providing information related to the images to a trained statistical model. In some embodiments, the images may be processed to help identify or otherwise emphasize the presence of various recoating defects on the build surface prior to fusing of the precursor material. The information may be provided in a number of different ways including, but not limited to raw images of the build surface, a recoating defect map, preprocessed images, binary masks generated using the images, arrays of information related to a state of different portions of the build surface, and/or any other appropriate type of information.

In some cases, one or more recoating defects present in a single layer of a part during a build process may not result in the formation of a part defect, or it may result in a part defect of relatively low severity that is not of concern with regards to control of an additive manufacturing process. For example, a recoating defect such as a short feed occurring on one layer may not render a part defective. However, a plurality of recoating defects occurring over multiple layers in a part may result in formation of a part defect of concern. Thus, the Inventors have recognized that considering information related to multiple layers, such as images of a plurality of recoated layers potentially including corresponding recoating defects, may be used to predict the formation of potential part defects in additive manufacturing systems. More specifically, the inventors have recognized that providing information related to images of a plurality of layers of recoated precursor material prior to fusing to a trained statistical model may be used to predict the formation of these part defects. In some embodiments, detected defects may be used to form defect maps, arrays of information related to the location, type, and/or severity of the part defects, and/or any other appropriate way of organizing this information.

As elaborated on further below, certain types of low-severity part defects associated with overhanging geometries, are commonly misidentified as high-severity defects at least in part due to their similarity in images with respect to certain defects including short feed recoating defects. This inclusion of lower severity recoating defects may result in controlling an additive manufacturing system to perform corrective actions that are unnecessary, wasteful, and/or harmful to the overall part quality. The inventors have recognized that in some embodiments certain types of defects may be associated with unsupported geometries of a part being formed, and that these regions are typically associated with specific process parameters including, for example, lower fusing energies relative to fusing energies associated with other supported portions of the parts. Accordingly, a fusing energy associated with the identified recoating defects within an image may be used to distinguish between different types of recoating defects in some embodiments. For example, a fusing energy threshold, or predetermined lower energy mode, associated with the provided build plans may be used to identify low fusing energy areas. Identified recoating defects associated with these lower fusing energies may be omitted from consideration in some embodiments.

As used herein, a fusing energy map may correspond to a map of the energy input to the various portions of a build surface. In some embodiments, a fusing energy map may represent the commanded input energy by one or more laser energy sources used to fuse different portions of a layer of precursor material on the build surface, though instances in which the measured laser power, scan rate, and/or other process parameters are used to determine the energy input are also contemplated. In some embodiments, a series of sequential fusing energy maps may include information related to energy applied to different portions of the corresponding sequential layers used during a build process to form a part. However, it should be understood that a fusing energy map may represent the input energy for any number of parts.

As previously discussed, defects may be detected at least in part using information associated with images of a build surface. In some cases, the images may be provided to trained statistical models to predict part defects. However, including information related to recoating defects that are unlikely to result in part defects, or that may become more severe if corrective measures are attempted, may complicate this analysis. Accordingly, in some embodiments, the one or more images of one or more layers of recoated precursor material prior to fusing may be preprocessed prior to being provided to the trained statistical model. This may include preprocessing the images using the above noted fusing energies, and optionally one or more fusing energy maps, to omit recoating defects associated with low energy areas that are below a threshold energy, set to a commanded lower energy setting, have a lower fusing energy than other fused portions of a build surface, and/or are otherwise indicated as being a low fusing energy area. Thus, potential part defects in a current layer prior to fusing may be based at least in part on the one or more images and the one or more fusing energy maps.

The statistical models referred to herein may be any appropriate statistical model and may be trained using any appropriate method and/or machine learning method. As described further elsewhere in this application, training data may be provided to a training module to create a trained statistical model. Appropriate training methods may include, but are not limited to supervised learning, unsupervised learning, deep learning, reinforcement learning, deterministic and stochastic gradient-based optimization, boosting methods, genetic algorithm and/or any other appropriate training method. Appropriate statistical models that may be used for the statistical defect prediction models for the various embodiments disclosed herein may include, but are not limited to, regression models, decision tree models, random forest models, gaussian process models, probabilistic graphical models, support vector machines, Naive Bayes models, principal component analysis (PCA) models, neural networks (e.g., convolutional neural network), and any other appropriate type of statistical model.

As previously noted, it may be desirable to identify recoating defects on a build surface recoated with a layer of precursor material for various uses including, for example, controlling a recoating process and/or to aid in predicting the formation of potential part defects. Relatedly, the Inventors have recognized that uncovered fused material on a recoated build surface material may reflect light at a greater intensity than the surrounding unfused precursor material. Thus, the presence of high intensity light in an image of a recoated build surface may be indicative of various types of recoating defects where fused portions of an underlying layer are exposed. For example, this may be indicative of a short feed defect. Accordingly, in some embodiments, one or more images of a recoated build surface including a layer of precursor material may be obtained. While the image may correspond to any layer of a build process, in some embodiments, the obtained one or more images may correspond to a current layer of the build process and optionally one or more prior sequential layers of the build process. These images may either be obtained by recalling them from memory and/or they may be captured in real time during an additive manufacturing process using any appropriate photosensitive detector. These one or more images may be used to identify recoating defects in the one or more layers based at least in part on light intensities in the images. For example, light intensities of pixels in the images may be compared to a light intensity threshold and pixels with light intensities greater than the threshold may be identified as corresponding to potential recoating defects. To avoid potential misidentification of recoating defects it may also be desirable to use a size threshold for identifying recoating defects in some embodiments. This may include comparing a size of groups of contiguous pixels with intensities greater than the threshold light intensity to a size threshold to omit groups of contiguous pixels with sizes less than the size threshold.

The above methods and systems may be used to identify a number of different types of recoating and/or part defects. Appropriate types of recoating defects that may be identified may include but are not limited to short feeds, drag lines, flinging, chatter lines, and/or any other appropriate type of recoating defect. In some embodiments, short feeds are identified using the disclosed methods and system. Appropriate types of part defects that may be identified may include voids, unfused precursor material, delamination (i.e., a portion of a fused build layer delaminating from an adjacent underlying build layer of a part), visible defect lines and/or any other appropriate type of part defect.

As discussed above, in some embodiments one or more images of a build surface for one or more layers, and in some embodiments a plurality of sequential layers, may be used to identify recoating defects and/or to predict the formation of part detect defects during an additive manufacturing process. In some embodiments, the one or more images of the build surface may be obtained after a layer of precursor material has been deposited (i.e., recoated) onto the build surface and prior to fusing of the precursor material. It should be understood that any number of images may be obtained for each layer. For example, if a field of view of a photosensitive detector covers an entire build surface, a single image per layer may be taken. Alternatively, in instances where a plurality of photosensitive detectors are used or where a photosensitive detector is scanned across a build surface to image the build surface, a plurality of images may be taken of the build surface for each layer. Thus, the current disclosure is not limited to how the images are taken and/or the number of images taken to characterize a desired portion of a build surface. Additionally, it should be understood that any appropriate type of photosensitive detector capable of imaging the surface may be used including, but not limited to, area cameras and line scan cameras.

In some embodiments, the detected recoating defects and/or predicted part defects may be used to control one or more aspects of an additive manufacturing process. For example, this may include manual control where the information may be provided to an operator who may then manually control one or more operations of the build process. For instance, a detected short feed may be output to an operator who may then control the system to scrape the build surface in an attempt to correct the short feed defect. Additionally, providing information relating to defects associated with one or more parts to an operator may optionally help to inspect the parts for quality. Information relating to defects associated with one or more parts may include the location, type, and/or severity of the defects. Providing this information may allow operators to identify defective parts more quickly and accurately, thereby saving on time and cost.

In some embodiments, one or more operations of an additive manufacturing system may be controlled automatically based at least in part on identified recoating defects and/or predicted formation of potential part defects. Depending on the detected recoating defects and/or predicted formation of potential part defects, one or more corrective actions may be taken. The corrective actions may include controlling one or more operations of the additive manufacturing system, stopping or pausing one or more build processes, adjusting one or more process parameters, rescraping the build surface, recoating the build surface, and/or any other action or adjustment that may mitigate, or potentially eliminate, the noted defects. Appropriate process parameters that may be adjusted include, but are not limited to, laser power, scanning speed, temperature, recoating speed, layer thickness, and/or any other appropriate process parameter that may be adjusted to mitigate the formation of one or more identified and/or predicted defects.

Typical identification of recoating defects and part defects by an operator is both a manually intensive process and is very dependent on operator skill and experience. Thus, using the disclosed methods and systems offer various benefits. For example, the automatic detection and/or prediction of defects may permit the faster detection of these defects with less reliance on user skill and/or may mitigate the formation of the predicted defects. This may offer improved part yields, materials savings, time savings, and less reliance on manual observation and intervention by users during an additive manufacturing process. Of course, embodiments in which the above benefits are not provided and/or different benefits are provided are also possible as the disclosure is not limited in this fashion.

It should be understood that the present disclosure may be applicable to any appropriate additive manufacturing system or method where a layer of precursor material is deposited onto a build surface prior to melting, sintering, reacting, and/or otherwise being fused together to form a part during an additive manufacturing process. For example, the systems and methods disclosed herein may be used in whole or in part in any laser powder bed fusion additive manufacturing systems, selective laser sintering (SLS) additive manufacturing systems, electron-beam melting (EBM), and/or any other appropriate additive manufacturing systems as the disclosure is not so limited.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 KW). For example, the power output for each laser energy source may be between about 100 W and about 1.5 kW, and/or between about 500 W and about 1 kW. Moreover, a total power output of the plurality of laser energy sources may be between about 500 W (0.5 KW) and about 4,000 kW. For example, the total power output may be between about 1 KW and about 2,000 kW, and/or between about 100 KW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

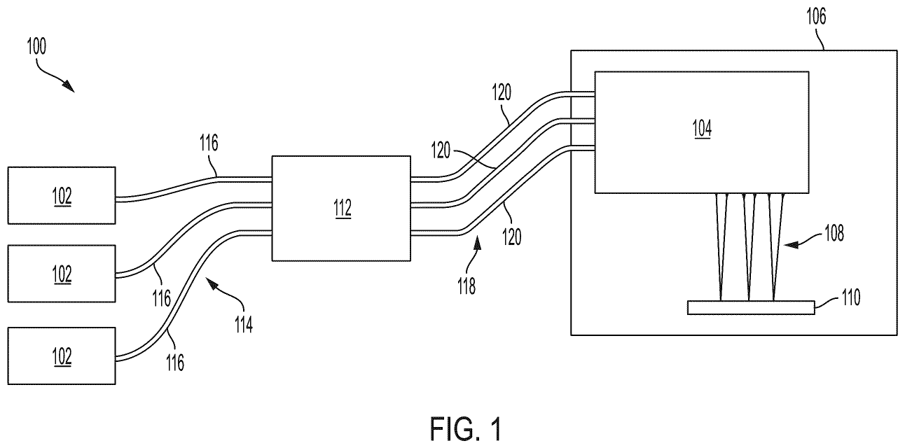

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course other methods of connecting the laser energy sources 100 due to the optics assembly 104 are also contemplated.

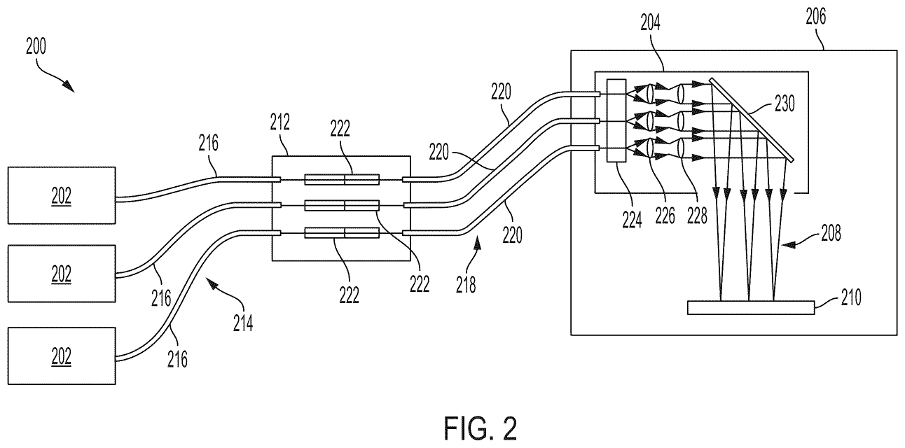

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

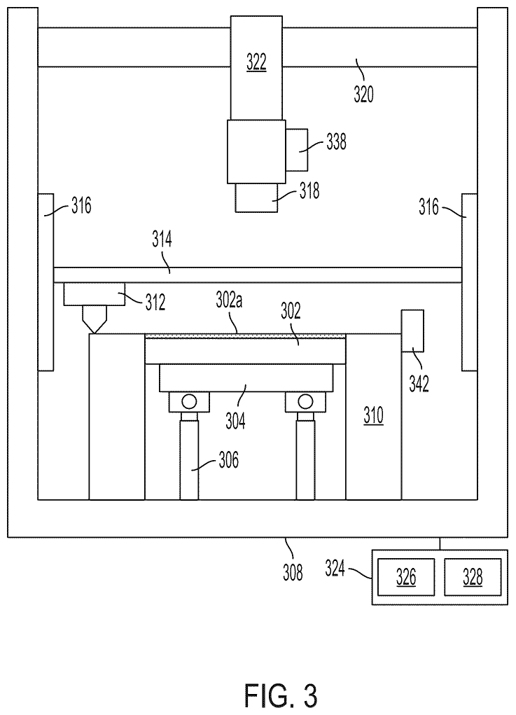

FIG. 3 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 322 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller may include one or more processors 326 and associated non-transitory computer readable memory 328. The non-transitory computer readable memory may include processor executable instructions that when executed by the one or more processors cause the additive manufacturing system to perform any of the methods disclosed herein.

In some embodiments, one or more photosensitive detectors 338 may be configured to image at least a portion of the build surface and/or surface of the build plate 302. For example, the one or more photosensitive detectors 338 may be configured to move in sync with the optics assembly 318 such that the one or more photosensitive detectors may image the build surface as the optics assembly scans the corresponding laser energy pixels across the build surface to selectively form welds thereon. Thus, the one or more photosensitive detectors may still image a relevant portion, and in some instances the entire build surface, during formation of each layer. This scan based imaging of the build surface may permit detectors with smaller fields of view and lower resolutions to be used, though it should be understood that photosensitive detectors with any appropriate field of view and resolution may be used depending on the application.

As noted above, the one or more photosensitive detectors 338 may be movable with respect to the surface of the build plate 302. Optionally, the photosensitive detectors 338 may be coupled to the optics assembly 318 and may move together with the optics assembly. In other embodiments, the photosensitive detectors may be coupled to the gantry 320 and/or the vertical motion stage 322. In further embodiments, the photosensitive detectors may move independently of the movement of the optics assembly 318 and vertical motion stage 322. For example, the photosensitive detectors 334 may be coupled to a separate movable y-bridge or other appropriate motion stage. In either case, the one or more photosensitive detectors 334 may be configured to obtain images from an orientation that is substantially perpendicular to the surface of the build plate to obtain top-down images of the powder bed and welded surfaces in the various embodiments described herein.

To help with imaging, an additive manufacturing system may also include one or more light sources 342 configured to illuminate the build surface of the build plate 302. In some embodiments, the one or more light sources 342 may be configured to provide light that has a direction of primary propagation that is approximately parallel to the top surface of the build plate (i.e., the light sources may be oriented parallel to the build surface).

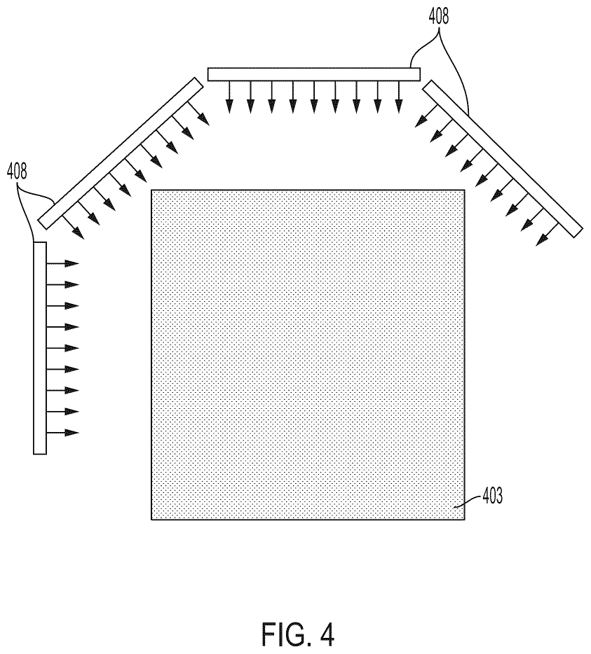

FIG. 4 shows an arrangement of one or more light sources 408 and a build surface 403 according to some embodiments. The one or more light sources 408 may be configured to direct light onto at least a portion of the build surface 403. In some embodiments, the light sources 408 may be configured to emit light in a direction that is substantially parallel to the build surface 403 (e.g., a direction of primary light propagation may be substantially parallel to the build surface). The light sources 408 may be located at any location and orientation around a perimeter of the build surface 403 to provide light to the build surface. Optionally, a plurality of light sources 408 may partially or completely surround the build surface to illuminate the build surface from multiple different directions. Thus, by selectively activating the light sources, the direction of light illumination on the build surface 403 may be controlled which may help to facilitate imaging of different types of defects that may be present on a build surface. Appropriate types of light sources may include, but are not limited to spot lights, bar lights, LED strip lights, focused beam lights, focused electron beam. As noted above, in some embodiments, one or more photosensitive detectors may be configured to obtain one or more images of at least a portion of the build surface 403 containing a recoated layer of precursor material on the build surface 403. In some embodiments, the photosensitive detectors may be configured to obtain grayscale images of the build surface 403. In other embodiments, colored images may be obtained using the photosensitive detectors.

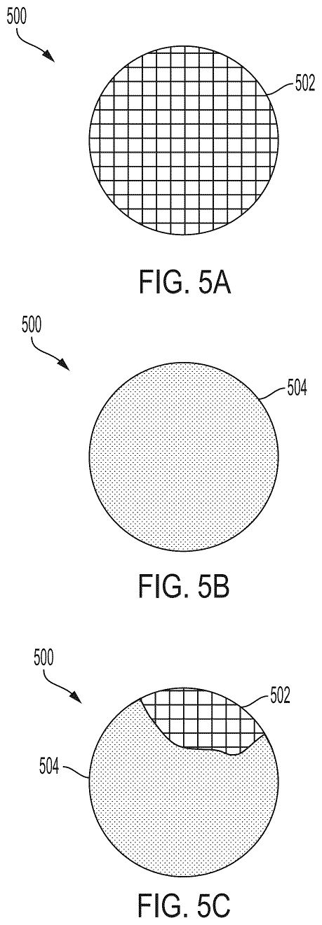

FIGS. 5A-5C depict one an embodiment of a type of recoating defect that may occur during a recoating process FIG. 5A shows a top view of a portion of a build surface including a part after a layer of material has been fused according to some embodiments. The part area 500 as shown represents a circular geometry after a layer of precursor material has been fused. The entire part area 500 is material that is properly fused, resulting in a part area 500 with only fused material 502 exposed on the build surface. In some embodiments having lighting arrangements such as those described above, the fused material 502 may reflect light at an intensity greater than any surrounding precursor material (surrounding precursor material not shown in FIGS. 5A-5C).

FIG. 5B shows a top view of the part after a recoating process that does not include any recoating defects. The part area 500 represents the same circular geometry as shown in FIG. 5A after a layer of precursor material has been deposited. The entire part area 500 is properly recoated, resulting in a part area 500 with only recoated material 504 exposed to the build surface. In some embodiments including lighting arrangements such as those described above, the recoated material 504 may reflect light that may be imaged by a photosensitive detector of the system. As described in further detail elsewhere, unfused precursor material in a recoated layer may reflect light at a lower intensity than fused material. Thus, the light observed in the depicted portion of the build surface including the part in FIG. 5B may exhibit a lower light intensity as compared to the fused material in FIG. 5A.

FIG. 5C shows a top view of the part after a recoated layer of precursor material including a recoating defect is deposited according to some embodiments. Again, the depicted portion of the build surface including the part area 500 represents the same circular geometry as shown in FIG. 5A and FIG. 5B. However, the part area 500 is improperly recoated such that the layer of precursor material does not completely cover the underlying layer of fused material. This results in a portion of the fused material 502 of the prior layer still being exposed while other portions of the prior layer are covered with the new layer of recoated precursor material 504. This defective recoating may be referred to as a short feed defect, wherein the material distribution does not sufficiently cover the fused material 502.

With regards to short feed recoating defects, this type of defect may be formed in portions of parts that are not directly connected to the underlying build plate and are unsupported by previously built layers. The lack of support and/or connection may allow the structure to shift or distort from the intended position of the structure, resulting in unpredictable and potentially uneven surfaces. The deformations may be due at least in part to thermal stresses induced in the region during fusion. For example, a first portion of a current layer being fused may not have previously fused material disposed underneath on the preceding layer, and the resulting fused material of the first portion may accordingly be lower than the rest of the fused portions of the current layer. The proceeding recoat may not provide enough material to substantially cover the first portion, resulting in a short feed defect. Resultingly, fused material may be exposed to the build surface after the recoat.

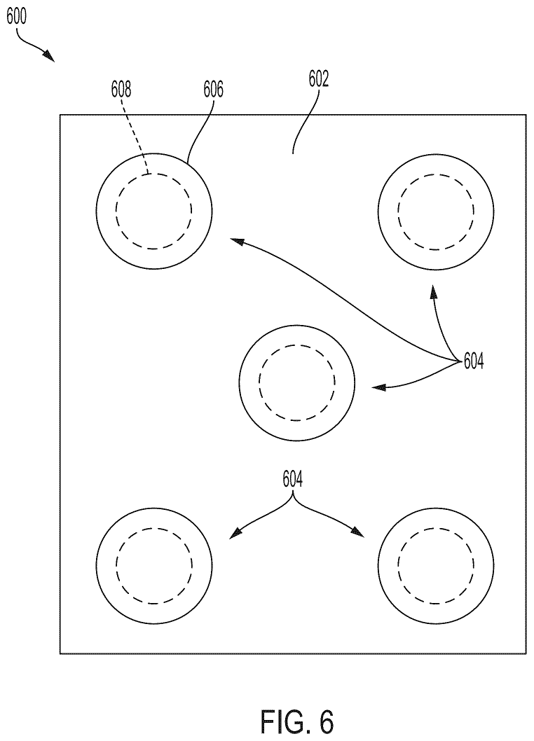

As previously described, in some embodiments, a fusing energy map may be used at least in part as part of a process to predict the formation of part defects. FIG. 6 shows one exemplary embodiment of a fusing energy map 600. In some embodiments, a fusing energy map 600 may be a map of a build surface including information related to the energy applied to the build surface by one or more energy sources (e.g., one or more laser energy sources) during fusing of a layer of precursor material on the build surface 602. In other words, a fusing energy map 600 may include information related to energy applied to different portions of the build surface 602. In some embodiments, the information may be provided as commanded weld paths, scan rates, power, specific energy, and/or any other appropriate type of information related to the energy input to the different portions of a build surface during formation of a specific layer. For example, in some embodiments, a movement speed of an optics assembly and/or the laser pixels relative to a build surface may be constant during active weld formation. Thus, the power supplied to the laser energy sources may be correlated with, or used in place of, the energy applied to the build surface. However, embodiments in which variable speeds and/or laser energy sources varying in power, repetition rate, laser-on-time percentage, or any other appropriate variation are used to vary the energy input to one or more portions of a build surface are also contemplated.

Depending on the embodiment, either a single fusing energy map including the above noted information may be provided for a current layer or a plurality of fusing energy maps may be provided as part of a part prediction process. in instances where a plurality of fusing energy maps are used, the fusing energy maps may be provided for a current layer, one or more prior layers, a plurality of previously formed layers, and/or combinations of the foregoing.

In the depicted embodiment of a fusing energy map 600, the fusing energy map may optionally represent the input energy for the build surface 602 in a single layer containing one or more parts. Each part on the build surface may have one or more associated fusing energy regions 604 which again may correspond to portions of the layer to be fused and may correspond to one or more weld paths. In the shown embodiment, the fusing energy regions 604 are represented by a plurality of circles with different associated input energies. For example, a first fusing energy line 606 and a dashed line representing a second fusing energy line 608 are depicted. In some embodiments, the first fusing energy line 606 may correspond to a first fusing energy and the second fusing energy line 608 may correspond to a second fusing energy that is less than the first fusing energy. Such an arrangement may be useful when creating hollow structures. Of course, while parts with two separate regions formed with two different fusing energies are depicted, any appropriate number and arrangement of fusing energy regions may be used to form any appropriate part geometry as the current figure is for exemplary purposes.

While the above embodiment of a fusing energy map 600 is represented visually, it should be understood that fusing energy maps may be provided in different formats as well. For example, the information included in a fusing energy map may include location and power information related to the different portions of a build surface, this may include information related to individual pixels on a build surface, an array of commanded fusing energies, coordinates associated with low energy areas and/or areas where fusing does not occur, and/or any other information that can be used to coordinate the location of portions on a build surface that are subjected to different intensities of fusing energy during a build process.

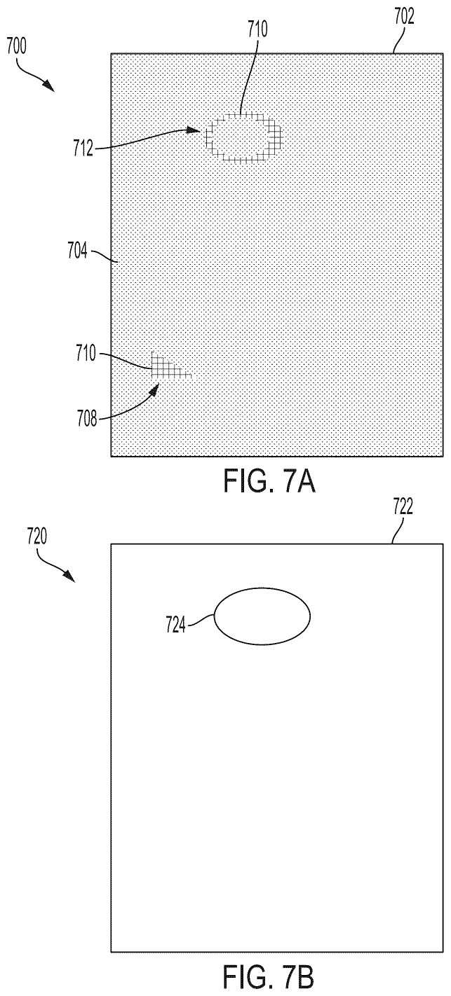

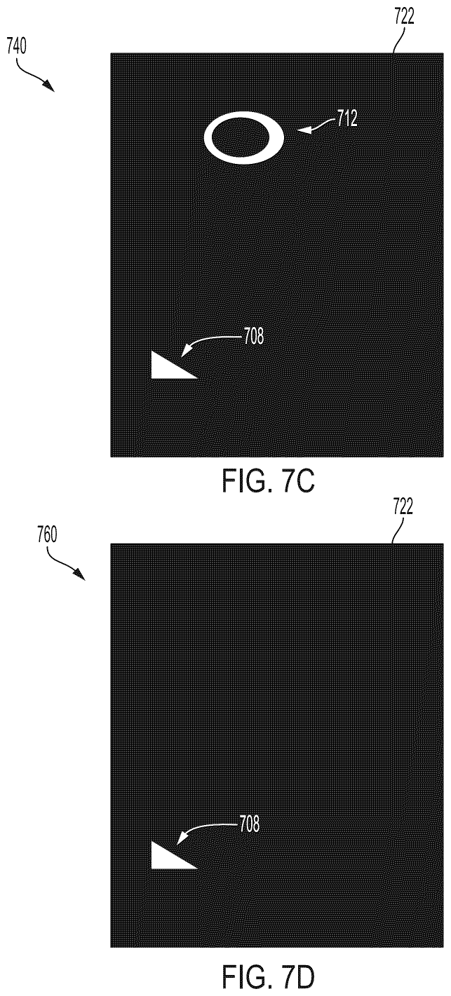

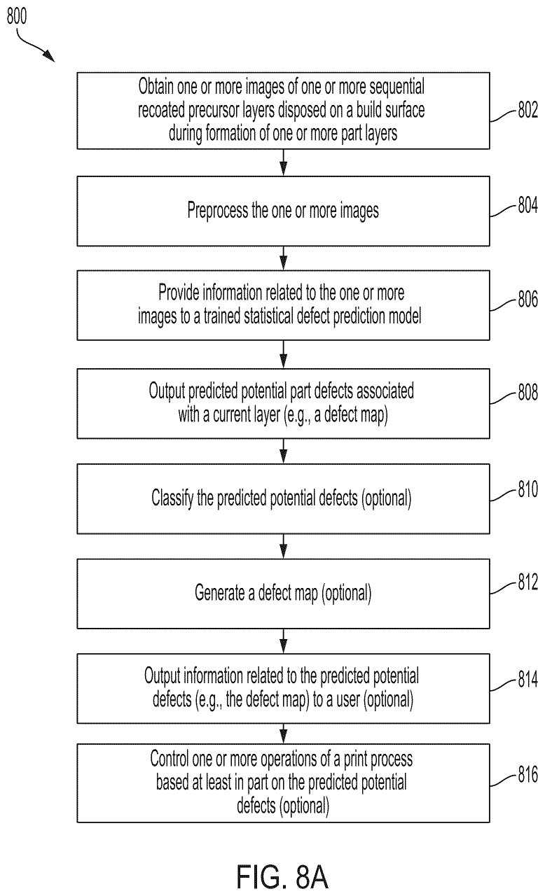

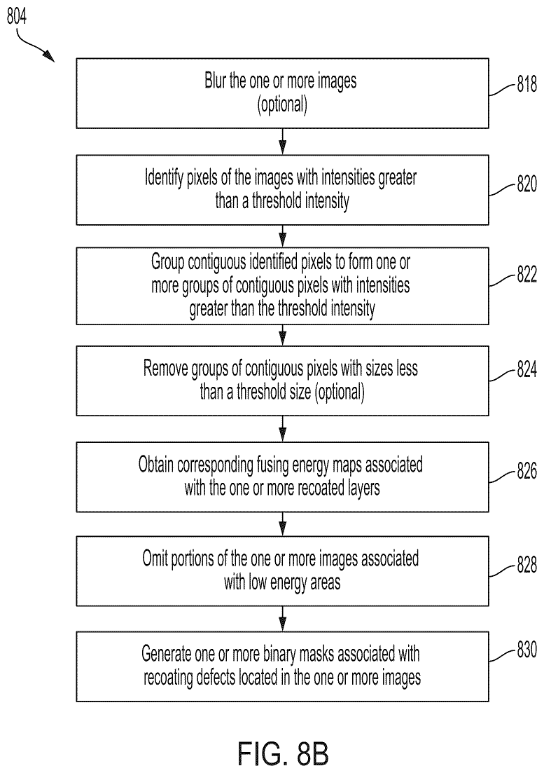

FIG. 8A shows a flow diagram of one embodiment of a method 800 for predicting the formation of potential part defects that may be formed during fusing of a current layer of recoated precursor material disposed on a build surface of an additive manufacturing system. The method 800 may include obtaining one or more images of one or more sequential recoated precursor layers disposed on a build surface during formation of one or more part layers, see 802. In some embodiments, the images may be grayscale, colored, or any other appropriate type of image. In instances where multiple images are used, the images may include a current layer being evaluated and optionally one or more images of previous recoated layers. In instances where a single images is used, the image may correspond to a current layer being evaluated to predict potential part defect formation. An example of one such image is shown in FIG. 7A which shows an image 700 of a layer including a recoated layer of precursor material on build surface 704 containing multiple parts being built including recoating defects. The image 700 shows fused material 710 exposed to the build surface as a result of a short feed defect 708 and a low-severity recoating defect resulting from an overhanging geometry 712. As previously discussed, the low-severity recoating defect may result from an overhanging geometry 712 that overhangs an unsupported portion of the build surface. In the shown embodiment, both the low-severity recoating defect resulting from an overhanging geometry 712 and the short feed defect 708 may result in fused material 710 being exposed to the build surface 704.

In some embodiments, the above raw images may be used to predict the formation of part defects. However, additional preprocessing of the images may aid in predicting formation of the part defects and/or distinguishing between low-severity recoating defects and high-severity recoating defect, see 804 in FIG. 8A. One potential embodiment for preprocessing the one or more images of a recoated build surface is expanded in FIG. 8B. Due to the stochastic nature of light intensity of light reflected off of randomly arranged powder particles, individual pixels of an imaged build surface may either be higher or lower than the average signal. Therefore, it may be desirable to provide a more uniform signal that accounts for these expected variations in the imaged light intensity. Accordingly, in some embodiments, the one or more images may be blurred at 818. As will be described further, the intensity of light within the images may be analyzed in the process of detecting recoating defects. Thus, blurring the images may smooth the variations in the observed light intensity between contiguous pixels within the image. In other words, blurring may smooth the transition of light intensity among neighboring pixels. This may reduce or remove noise from the images. In some embodiments, the images may be blurred using a large smoothing kernel. However, blurring may be accomplished using any other appropriate blurring algorithm as the disclosure is not so limited.

The next step in the preprocessing may involve identifying pixels within the image that have light intensities greater than a threshold intensity which may be associated with exposed welds from a prior layer at 820. The threshold intensity may be set at any appropriate value depending on the type of precursor material, weld parameters, lighting parameters, and/or any other parameter that may affect the intensity of light reflected from the precursor material and resulting welds as the disclosure is not so limited. Contiguous pixels having light intensities above the threshold intensity may be grouped together at 822 using any appropriate grouping algorithm including, but not limited to, morphological dilations and closing of contiguous pixels. In some embodiments, groups of contiguous pixels with sizes less than a threshold size may optionally be removed, see 824. Again, to avoid the inclusion of either minor defects and/or areas that are unlikely to result in the formation of part defects, in some embodiments, groups of contiguous pixels above the threshold light intensity but with sizes below a threshold size may optionally be removed from the preprocessed image. The threshold size may be any appropriate size depending on the types and severity of part defects that are to be identified. For example, in some embodiments, a threshold size may be set to exclude groups with sizes less than the threshold sizes detailed previously above. Of course, size ranges both greater than and less than those noted above are also contemplated as the disclosure is not limited in this fashion. In some embodiments, pixels and/or contiguous groups of pixels having light intensities above a threshold intensity may be omitted if they are within a threshold distance of an outermost edge of a build surface. The inventors have recognized that pixels above the threshold intensity that are proximate to an outermost edge of the build surface likely do not represent recoating defects that need to be corrected as these areas are unlikely to include parts that are being formed. The threshold distance may be any appropriate value selected to define this border region of the build surface where parts are not formed.

After identifying groups of pixels corresponding to potential recoating defects, in some embodiments, one or more fusing energy maps associated with the images of the one or more recoated layers may be obtained at 826. FIG. 7B shows an exemplary embodiment of a fusing energy map 720 that may be associated with the image of the recoated layer of FIG. 7A. In the depicted embodiment, the fusing energy map 720 may have the same spatial resolution as the associated image 700. The fusing energy map 720 may be used to determine regions of the build surface 704 have higher or lower fusing energies. In the shown embodiment, the fusing energy map 720 has one or more low energy regions 724 that are fused using lower energy than other portions of the build surface which are fused using larger fusing energies per unit area. In the depicted embodiment, the low energy region is associated with the location of the low-severity recoating defect resulting from an overhanging geometry 712. Thus, in some embodiments, the portion of the image 700 associated with the corresponding low energy region 724 may be omitted from the one or more images at 828. In some embodiments, if a fusing energy map 720 contains a plurality of low energy regions 724, each portion of the image 700 corresponding to the location of the plurality of low energy regions may be omitted.

While the information from the preprocessed images may be provided in any appropriate manner, in some embodiments, a binary mask of the build surface may be generated to highlight which portions of the build surface in the one or more images 700 have recoating defects at 830. In some embodiments, the binary mask may have the same spatial resolution as the one or more corresponding images and fusing energy maps. One embodiment of this process and the exclusion of select portions of the image after being turned into a binary mask is shown relative to FIGS. 7C and 7D. In the embodiment shown in FIG. 7C, a binary mask 740 is generated corresponding to the image 700 with those portions of the image with light intensities greater than the threshold intensity may be assigned a positive intensity value (e.g., 1 or some other number) and those regions less than the threshold intensity may be assigned a lower intensity value (e.g., 0). In the resulting initial binary mask, the properly recoated portions are shown in black and recoating defects are shown in white. The white portion in the upper region of the binary mask 740 corresponds to the low-severity recoating defect resulting from an overhanging geometry 712 and the low energy region 724 shown in the fusing energy map of FIG. 7B. The white portion in the lower region of the binary mask 740 corresponds to the short feed defect 708. A binary mask need not be represented visually. For example, the information comprising a binary mask may simply be an array or matrix of values indicating whether a defect is present or not.

As previously described, the white portion in the upper region of the binary mask 740 corresponds to the low severity defect 712 associated with the low energy region 724 may be omitted to form a final binary mask. Similarly, groups of pixels below a size threshold may be omitted from the final binary mask. Thus, once appropriately modified based on the use of various thresholds and/or a fusing energy map, a final binary mask 760 may be generated, see FIG. 7D. Depending on the specific embodiment, the final binary mask 760 may indicate the presence of various recoating defects including, for example, a short feed defect 708 as shown in the figure while omitting recoating defects associated with low energy areas, sizes below a threshold size, and/or are otherwise considered to be low-severity and unlikely to impact final part quality. In some embodiments, the final binary mask 760 may be considered a preprocessed image. Essentially, the final binary mask 760 omits low-severity defects and indicates high-severity defects. The preprocessed image and/or any other information related to the image may then be used for any desired process as disclosed herein.

In the above embodiments, any appropriate energy threshold may be used to identify low energy areas. For example, an energy threshold for identifying low energy areas on a build surface may be less than 100% of nominal energy, less than or equal to 75%, and/or any other appropriate energy threshold. The energy threshold may also be greater than 0% of nominal energy or greater than or equal to 25%, and/or any other appropriate energy threshold. Combinations of the foregoing are contemplated including, for example, an energy threshold that is between or equal to 25% and 75%. Of course, energy thresholds both greater than and less than those noted above are also contemplated as the disclosure is not so limited. Also, while particular combinations and ranges of thresholds are provided above, ranges both greater and less than those noted above are also contemplated as the disclosure is not so limited.

In the above embodiments, any appropriate size threshold may be used to identify potential recoating defects for being omitted from consideration as recoating defects and/or for providing to models for predicting part defects. For example, a size threshold may be less than or equal to 10000 mm², 1000 mm², 100 mm², and/or any other appropriate size threshold. The size threshold may also be greater than or equal to 0.1 mm², 1 mm², 10 mm², and/or any other appropriate size threshold. Combinations of the foregoing are contemplated including, for example, a size threshold that is between or equal to 1 mm² and 100 mm². Of course size thresholds both greater than and less than those noted above are also contemplated as the disclosure is not so limited.

Turning again to FIG. 8A, information related to the one or more images may be provided to a trained statistical defect prediction model at 806. In some embodiments, the information may be the preprocessed images and/or binary masks discussed above relative to FIG. 8B, though any other appropriate forms of information related to the presence of recoating defects within the one or more images may be used as previously discussed. Potential part defects may be predicted by the trained statistical defect prediction model and may be output at 808. Depending on the embodiment, the predicted defects may be provided in any appropriate fashion. For example, in some embodiments, a defect map indicating the location of the predicted part defects in on the build surface within a current layer may be generated at 812. Alternatively, the predicted part defects may be provided as: arrays including classification information corresponding to the build surface (e.g., type of defect and location within the array); individual part defects with size and location information; and/or any other appropriate type of information. Optionally, in some instances, the statistical model may also predict a severity and/or type of part defect. Thus, the part defects may be classified according to number, type, location, proximity to other defects, severity, any combination of the forgoing, and/or any other appropriate type of defect characteristic at 810.

In some embodiments, information related to the predicted potential defects may be output to a user at 814. This may take many forms. For example, one or more predicted defect characteristics may be provided to a user for a current, and in some instances prior build layers. This may include: displaying the defect map to a user; displaying numbers, type, location, proximity to other defects, severity, and/or other information to a user with a display; and/or any other appropriate method of outputting the information to a user to aid their monitoring and/or control of the current additive manufacturing process. In some embodiments, a user may intervene with and/or otherwise alter an additive manufacturing process based on the output information. However, such manual intervention in a manufacturing process is oftentimes very dependent on the user's experience and skill.

In view of the above, the prediction of potential part defects may also enable control of an additive manufacturing system based on these predictions. For example, in some embodiments, one or more operations of an additive manufacturing system may be controlled based at least in part on the predicted formation of one or more part defects at 816. For example, depending on the number, type, size, and/or severity of a type of predicted part defect, a controller may control the additive manufacturing system to perform one or more potential actions to at least partially remediate, or eliminate, predicted part defects. This may include controlling a recoater of an additive manufacturing system to perform a scrap and/or recoat of the build surface to attempt to correct a recoating defect, such as the short feed defect 708 depicted in FIGS. 7A-7D. Other appropriate operations the additive manufacturing system may be controlled to perform based at least in part on the predicted formation of one or more part defects may include, but are not limited to, pausing a build process, aborting a build process, aborting one or more parts with numbers of part defects greater than an acceptable threshold and/or parts including part defects of a particular severity, and/or any other appropriate action.

As described further in proceeding paragraphs, information related to the images may be provided independently from or in combination, fusing energy maps, build plans with part geometries, and/or other process parameters to the disclosed statistical models. For example, part build geometries included in the build plans may be used to identify defects that are associated with parts within a build layer versus defects that are included in portions of a build layer that are not associated with parts being formed and that can be disregarded in some embodiments.

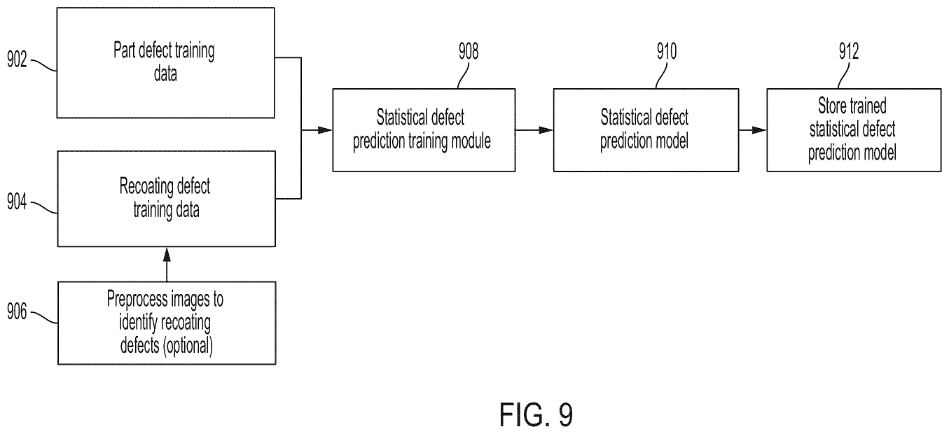

As previously mentioned, statistical models may be used to predict the formation of part defects in some embodiments. FIG. 9 depicts an embodiment related to training a statistical defect prediction model for use with the disclosed additive manufacturing systems. Training data may be input into a training module, such as the depicted statistical defect prediction training module 908. In some embodiments, the training data may correspond to part defect training data 902 and recoating defect training data 904.

The recoating defect training data 904 may include information related to the presence of recoating defects in the plurality of layers used to form a plurality of separate parts. For example, images of recoated build surfaces may be used as the recoating defect training data. In some embodiments, the images may be preprocessed at least in part to identify recoating defects within the images, see 906. While any appropriate preprocessing of the images of the recoated layers, in some embodiments, a preprocessing method similar to that described above may be used. Thus, the recoating defect training data may correspond to a plurality of binary masks determined based at least in part on the images of the plurality of recoated build layers of the plurality of parts. However, the use of other types of recoating defect information may be used as well as the disclosure is not so limited.

The labeled part defect training data 902 that corresponds with the recoating defect training data for the various part layers may include information related to the presence of part defects in the corresponding manufactured parts. The information may be correlated with the layer based recoating defect training data. For example, a part defect may be formed in one or more specific layers which may be correlated with corresponding specific recoated layers in the recoating defect training data that were used to form the one or more layers the one or more part defects are located in. While various types of information may be included, part defect training data may include information such as part defect location and optionally severity of the defects. In one specific embodiment a build surface may be subdivided into individual build surface pixels and each build surface pixel may be assigned an indication related to whether or not a part defect is associated with that location or not.

Using the correlated training data, the statistical defect prediction training module 908 may output a trained statistical model based on the part defect training data and the recoating defect training data which may be referred to as a trained model may be referred to as a trained statistical defect prediction model at 910. The statistical defect prediction model may then be stored in an appropriate non-transitory processor readable memory for subsequent recall and/or use, see 912. Depending on the particular application, the processor and associated memory used to obtain and analyze the defect data may be integrated into a single system. However, embodiments in which the systems used to obtain the training data and train the desired trained statistical model are implemented on separate systems using separate processors are also contemplated.

In the above embodiment, appropriate training methods may include, but are not limited to supervised learning, unsupervised learning, deep learning, reinforcement learning, deterministic and stochastic gradient-based optimization, boosting methods, genetic algorithm, and/or any other appropriate training method. Appropriate statistical models that may be used for the statistical defect prediction models for the various embodiments disclosed herein may include, but are not limited to, regression models, decision tree models, random forest models, gaussian process models, probabilistic graphical models, support vector machines, Naive Bayes models, principal component analysis (PCA) models, neural networks (e.g., convolutional neural network), and any other appropriate type of statistical model.

The above noted training data may be obtained in any appropriate fashion by inspecting parts, obtaining images of recoated layers, obtaining process parameters, and any combination thereof. For example, one or more images may be captured of each recoated layer of a plurality of parts that are formed using a desired type of additive manufacturing process. The plurality of parts may then be inspected for the presence of part defects. When part defects are identified, their location within a part may be correlated with specific layers of the part (e.g., with specific recoating images) such that the part defect training data may be correlated with the recoating defect training data. To provide accurate predictions, it may desirable for labeled training data to be acquired from inspection of parts containing part defects as well as parts not containing part defects. Appropriate methods for obtaining information related to the presence of part defects may include, but are not limited to, visual inspection, microscopic inspection, cross sectional analysis, X-ray computed tomography (CT) imaging, and/or any other appropriate inspection technique which may be used to acquire labeled part defect training data. As noted above, corresponding methods for capturing the corresponding labeled part defect training data may include imaging of the corresponding recoated build surfaces of the different layers of the inspected parts, and optionally, these images may be preprocessed to provide the desired recoating defect training data.

Due to the time and cost requirements in acquiring this training data, and in some instances a model may be specific to a particular type of part being formed, the training data may be limited to a predetermined number of data points. Depending on the expected variations and complexity associated with a defect, either a larger or smaller number of data points may be needed to train the desired statistical model. For example, the number of training data points may be greater than or equal to 20 data points, 50 data points, 100 data points, 500 data points, or other appropriate number of data points. Correspondingly, the number of training data points may be less than or equal to 2000 data points, 1000 data points, 500 data points, and/or any other appropriate number of data points. Combinations of the foregoing are contemplated including, a number of training data points that is between or equal to 20 data points and 100 data points, 20 data points, and 2000 data points, and/or any other number of data points both greater than and less than the ranges noted above as the disclosure is not so limited. It should be understood that an appropriate number of datapoints may be reserved for verification of an accuracy of the trained statistical defect prediction model.

The various methods disclosed above may be implemented by one or more controllers including at least one processor operatively coupled to the various controllable portions of an additive manufacturing system as disclosed herein. Alternatively or additionally, in some embodiments, the disclosed methods may be performed at least in part, and in some instances completely, on a computing device that is separate and removed from the disclosed additive manufacturing systems. In either case, the disclosed methods may be embodied as computer readable instructions stored on non-transitory computer readable memory associated with the at least one processor such that when executed by the at least one processor the associated system, which may be an additive manufacturing system in some embodiments, may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

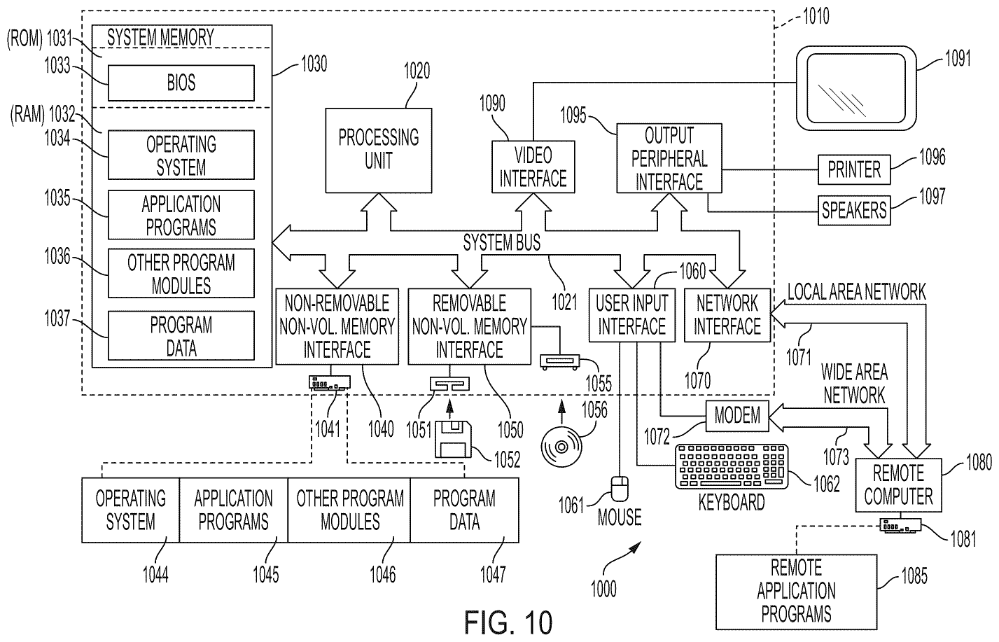

With reference to FIG. 10, an exemplary system for implementing aspects of the disclosure includes a general purpose computing device in the form of a computer 1010 or other appropriate computing device. For example, the depicted computing device may be used as a soil measurement planning system configured to implement any of the methods disclosed herein. Components of computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through an non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information into the computer 1010 through input devices such as a keyboard 1062 and pointing device 1061, commonly referred to as a mouse, trackball or touch pad. Other input devices (not shown) may include a microphone, joystick, game pad, satellite dish, scanner, or the like. These and other input devices are often connected to the processing unit 1020 through a user input interface 1060 that is coupled to the system bus, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through a output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communications link between the computers may be used.

The various methods or processes outlined herein may be implemented in any suitable hardware. Additionally, the various methods or processes outlined herein may be implemented in a combination of hardware and of software executable on one or more processors that employ any one of a variety of operating systems or platforms. Examples of such approaches are described above. However, any suitable combination of hardware and software may be employed to realize any of the embodiments discussed herein.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a build surface;
one or more laser energy sources;
an optics assembly configured to direct laser energy from the one or more laser energy sources toward the build surface;
a photosensitive detector configured to image at least a portion of the build surface;
a recoater configured to deposit sequential layers of precursor material on the build surface; and
at least one processor configured to perform the steps of:
obtain images of a plurality of layers of precursor material on the build surface prior to fusing using the photosensitive detector, wherein the plurality of layers include at least one previous layer and a current layer; and
predict formation of potential part defects in the current layer prior to fusing based at least in part on the images.

2. The additive manufacturing system of claim 1, wherein the at least one processor is configured to provide information related to the images to a trained statistical defect prediction model to predict the formation of the potential part defects in the current layer.

3. The additive manufacturing system of claim 2, wherein the at least one processor is configured to identify recoating defects in the images.

4. The additive manufacturing system of claim 3, wherein the at least one processor is configured to generate binary masks based at least in part on the identified recoating defects, and provide the binary masks to the trained statistical defect prediction model.

5. The additive manufacturing system of claim 3, wherein the at least one processor is configured to identify one or more portions of the image with light intensities greater than a threshold light intensity to identify the recoating defects.

6. The additive manufacturing system of claim 5, wherein the at least one processor is configured to identify contiguous groups of pixels of the images with intensities greater than the threshold intensity and a size greater than a threshold size to identify the recoating defects.

7. The additive manufacturing system of claim 3, wherein the at least one processor is configured to obtain a plurality of fusing energy maps, wherein the fusing energy maps include information related to energy applied to different portions of each layer of the plurality of layers, and wherein the at least one processor is configured to omit identified recoating defects associated with fusing energies less than a threshold energy.

8. The additive manufacturing system of claim 1, wherein the at least one processor is configured to control one or more operations of the additive manufacturing system based at least in part on the predicted formation of the potential part defects.

9. The additive manufacturing system of claim 8, wherein the one or more operations includes at least one selected from scraping and recoating the build surface with the recoater.

10. The additive manufacturing system of claim 1, wherein the at least one processor is configured to output the predicted formation of the potential part defects to a user.

11. The additive manufacturing system of claim 1, wherein the at least one processor is configured to blur the images.

12. A method for predicting part defects during an additive manufacturing process, the method comprising:
obtaining images of a plurality of layers of precursor material on a build surface of an additive manufacturing system prior to fusing, wherein the plurality of layers include at least one previous layer and a current layer; and
predicting formation of potential part defects in the current layer prior to fusing based at least in part on the images.

13. The method of claim 12, wherein predicting the formation of the potential part defects includes providing information related to the images to a trained statistical defect prediction model to predict the formation of the potential part defects in the current layer.

14. The method of claim 13, further comprising identifying recoating defects in the images.

15. The method of claim 14, further comprising generating binary masks based at least in part on the identified recoating defects, and providing the binary masks to the trained statistical defect prediction model.

16. The method of claim 14, wherein identifying the recoating defects is based at least in part on identifying one or more portions of the image with light intensities greater than a threshold light intensity.

17. The method of claim 16, wherein identifying the recoating defects includes identifying contiguous groups of pixels of the images with intensities greater than the threshold intensity and a size greater than a threshold size.

18. The method of claim 14, further comprising obtaining a plurality of fusing energy maps, wherein the fusing energy maps include information related to energy applied to different portions of each layer of the plurality of layers, and omitting identified recoating defects associated with fusing energies less than a threshold energy.

19. The method of claim 12, further comprising controlling one or more operations of the additive manufacturing system based at least in part on the predicted formation of the potential part defects.

20. The method of claim 19, wherein the one or more operations includes at least one selected from scraping and recoating the build surface.

21. The method of claim 12, further comprising outputting the predicted formation of the potential part defects to a user.

22. The method of claim 12, further comprising blurring the images.

23. The method of claim 12, further comprising fusing the precursor material with one or more laser energy pixels to form one or more parts on the build surface.

24. A non-transitory computer readable memory including instructions that when executed by at least one processor performs the method of claim 12.

25. A part manufactured using the method of claim 12.

26. A method of training a recoating defect detection statistical model, the method comprising:
obtaining training data, wherein the training data includes information related to part defects in a plurality of parts and information associated with images of recoated precursor material layers prior to fusing and associated with forming the plurality of parts;
generating a trained statistical defect prediction model using the training data; and
storing the trained statistical defect prediction model on non-transitory computer readable memory for subsequent use.

27-35. (canceled)

36. An additive manufacturing system comprising:
a build surface;
one or more laser energy sources;
an optics assembly configured to direct laser energy from the one or more laser energy sources toward the build surface;
one or more lights configured to illuminate the build surface;
a photosensitive detector configured to image at least a portion of the build surface;
a recoater configured to deposit sequential layers of precursor material on the build surface; and
at least one processor configured to perform the steps of:
obtain an image of at least a portion of the current layer prior to fusing the current layer using the photosensitive detector; and
identify recoating defects in the current layer based at least in part on light intensities in the image.

37-42. (canceled)

43. A method of detecting recoating defects on a build surface of an additive manufacturing system, the method comprising:
obtaining an image of at least a portion of the build surface with a recoated precursor layer disposed on the build surface; and
identifying the recoating defects based at least in part on light intensities in the image.

44-52. (canceled)

53. An additive manufacturing system comprising:
a build surface;
one or more laser energy sources;
an optics assembly configured to direct laser energy from the one or more laser energy sources toward the build surface;
a photosensitive detector configured to image at least a portion of the build surface;
a recoater configured to deposit sequential layers of precursor material on the build surface; and
at least one processor configured to perform the steps of:
obtain one or more fusing energy maps including information related to energy applied to different portions of one or more layers of precursor material on the build surface;
obtain one or more images of the one or more layers prior to fusing using the photosensitive detector; and
predict formation of potential part defects in a current layer prior to fusing based at least in part on the one or more images and the one or more fusing energy maps.

54-67. (canceled)

68. A method for predicting part defects during an additive manufacturing process, the method comprising:
obtaining one or more fusing energy maps including information related to energy applied to different portions of one or more layer of precursor material on a build surface of an additive manufacturing system;
obtaining one or more images of the one or more layers prior to fusing using a photosensitive detector; and
predicting formation of potential part defects in a current layer prior to fusing based at least in part on the one or more images and the one or more fusing energy maps.

69-85. (canceled)
